(19) United States
(12) Patent Application Publication
(10) Pub. No.: US 2015/0369709 A1
(43) Pub. Date: Dec. 24, 2015

(54) FILM REMOVING DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Dongliang Wang, Beijing (CN); Bin Feng, Beijing (CN); Ruirui Wang, Beijing (CN); Linlin Wang, Beijing (CN)

(21) Appl. No.: 14/522,531

(22) Filed: Oct. 23, 2014

(30) Foreign Application Priority Data
Jun. 24, 2014 (CN) 201410289294.4

(51) Int. Cl. G01N 1/32; G02B 21/00; G01B 3/00

(52) U.S. Cl. CPC G01N 1/32; G01B 3/004; G02B 21/00

(57) ABSTRACT

The present disclosure relates to the technical field of film thickness testing and discloses a film removing device. The film removing device includes a base, a carrying platform and a first baffle. The carrying platform is mounted on the base. A first side edge and a second side edge of the carrying platform are opposite to each other and in the direction from the first side edge towards the second side edge, the distance between the bearing surface and the base can be increased. The first baffle is mounted on the carrying platform and located on a side of the carrying platform facing away from the base. The first baffle has a sealing face, which is hermetically matched with a face of a substrate to be processed facing away from the carrying platform when the substrate to be processed is placed on the bearing surface; and a notch, inner walls of which are cooperated with the face of the substrate to be processed facing away from the carrying platform when the substrate to be processed is placed on the bearing surface so as to form a collecting slot opening to the first side edge of the bearing surface. The inner walls of the notch have a stop face facing towards the first side edge. The first baffle has a plurality of liquid guiding holes formed therein. The film removing device can create a distinct boundary after removing a portion of the film, so that the accuracy of the film thickness test can be increased.

### BACKGROUND OF THE DISCLOSURE

1. Field of the Disclosure

The present disclosure relates to a technical field of film thickness testing, in particular to a film removing device.

2. Description of the Prior Art

It needs to remove a portion of PI during the process of testing film thickness of a liquid crystal orientation layer PI by a step altimeter, and then the thickness of film can be determined according to a segment difference of the film thicknesses of the same layer. During the process of sample fabrication, because the etched position cannot be precisely determined, the removed position of film does not have distinct boundary. Therefore, the equipment cannot test the thickness of the film accurately.

### SUMMARY OF THE DISCLOSURE

The present disclosure relates to a film removing device. The film removing device can make the film have a distinct boundary after removing part of the film, so that the accuracy of film thickness test can be improved.

In order to achieve the above object, the present disclosure provides a film removing device. The film removing device includes a base, a carrying platform and a first baffle. A face of the carrying platform facing way from the base is bearing face. The carrying platform is mounted on the base. A first side edge and a second side edge of the carrying platform are opposite to each other. The first side edge is in parallel to a surface of the base facing towards the carrying platform. In the direction from the first side edge towards the second side edge, the distance between the bearing surface and the base can be increased. The first baffle is mounted on the carrying platform and located on a side of the carrying platform facing away from the base. The first baffle has a sealing face, which is hermetically matched with a face of a substrate to be processed facing away from the carrying platform when the substrate to be processed is placed on the bearing surface; and a notch, inner walls of which are cooperated with the face of the substrate to be processed facing away from the carrying platform when the substrate to be processed is placed on the bearing surface so as to form a collecting slot opening to the first side edge of the bearing surface. The inner walls of the notch have a stop face facing towards the first side edge. The stop face is in connection with the sealing face and the stop face forms a bottom face of the collecting slot opposite to the opening. The first baffle has a number of liquid guiding holes formed therein. The opening at one end of each of the liquid guiding holes is located at a side of the first baffle facing away from the carrying platform, and the opening at the other end is located at an inner wall of the notch.

When the film removing device is used to remove film, first, the substrate to be processed is flatly placed on the carrying platform, and the sealing face of the first baffle is hermetically matched with a face of the substrate facing away from the carrying platform. The inner walls of the notch are cooperated with the face of the substrate facing away from the carrying platform to form a collecting slot opening towards the first side edge of the bearing surface. The inner walls of the notch are provided with a stop face facing towards the first side edge of the bearing surface. When the etchant is introduced from the openings of the liquid guiding holes located at the side of the first baffle facing away from the carrying platform, the etchant can flow out from the openings of the liquid guiding holes located at the other end of the inner walls of the notch and can be collected in the collecting slot. Because in the direction from the first side edge towards the second side edge, the distance between the bearing surface and the base can be increased, that is, the bearing surface is gradually raised along the direction from the first side edge towards the second side edge, the etchant in the collecting slot can flow from the stop face towards the first side edge of the carrying platform towards which the stop face is facing. Therefore, the etchant can remove the film of the substrate when it passes by. In this way, the removed portion of the film can have distinct removed boundary at the stop face, so when the thickness of the film is determined based on segment difference, the tested thickness of the film can be more accurate.

In an embodiment, the carrying platform is provided with a slideway extending along the direction perpendicular to the first side edge. The first baffle can be mounted in the slideway in a way that the first baffle can slide along the extending direction of the slideway by means of a locking mechanism.

In an embodiment, the slideway is a slideway hole through the thickness direction of the carrying platform.

In an embodiment, the locking mechanism can be locking screw. The screw shaft of the locking screw can be in threaded fit with the first baffle through the slideway hole. A face of the screw cap of the locking screw facing towards the carrying platform is abutted against a surface of the carrying platform facing away from the bearing surface.

In an embodiment, the bearing surface of the carrying platform is formed with a first graduated scale whose graduations extend along a direction perpendicular to the first side edge of the bearing surface.

In an embodiment, the film removing device also includes a second graduated scale mounted on the first baffle. The second graduated scale and the first graduated scale can be matched to form a vernier caliper structure. The projection of the zero graduation line of the second graduated scale on the bearing surface is in the same line with the projection of the stop face on the bearing surface. It can be followed that the projection of the intersection line between the stop face and the surface of the substrate facing away from the carrying platform is in the same line with the projection of the zero graduation line of the second graduated scale on the bearing surface.

In an embodiment, the film removing device also includes a microscope mounted on the first graduated scale for reading the aligned state of graduations of the second graduated scale and the first graduated scale to obtain the readings of the vernier caliper. Because the projection of the intersection line between the stop face and the surface of the substrate to be processed facing away from the carrying platform is in the same line with the projection of the zero graduation line of the second graduation scale on the bearing surface, the position of the intersection line between the stop face and the surface of the substrate to be processed, that is, the initial position of the removed film, can be obtained, so that precise controlling and positioning of the initial position of the removed film can be achieved.

In an embodiment, the liquid guiding holes can be tapering through holes. The axis of the tapering through hole is perpendicular to plane where the bearing surface of the carrying platform is located. In the direction from the openings of the side of the first baffle facing away from the carrying platform towards the opening at the inner wall of the notch, the diameter of the tapering through hole is gradually decreased.

In an embodiment, at the first side edge of the bearing surface, the carrying platform is pivotally mounted on the base through a pivot shaft. The axis of the pivot shaft is parallel to the first side edge. A lifting device is connected between the base and the carrying platform to drive the carrying platform to rotate around the pivot shaft. The inclination of the bearing surface of the carrying platform can be controlled by the lifting device, so that the flow rate of the etchant from the stop face to the first side edge of the carrying platform towards which the stop face is facing can be controlled to make the removing of the film be more uniform.

In an embodiment, the film removing device also includes a second baffle mounted on the carrying platform and located on a side of the carrying platform facing away from the base. The side face of the second baffle facing towards the first baffle is in parallel to the stop face of the first baffle, and the second baffle is located at a side of the first baffle facing towards the first side edge of the bearing surface. By providing the second baffle, the removed portion of the film can be defined between the first baffle and the second baffle, defining the width of the removed film.

### BRIEF DESCRIPTION OF DRAWINGS

FIG. 1 is a schematic view showing a structure of a film removing device provided by an embodiment of the present disclosure.

FIG. 2 is a schematic view showing a structure of a first baffle of a film removing device provided by an embodiment of the present disclosure.

FIG. 3 is a schematic view showing a structure of a second baffle of the film removing device provided by an embodiment of the present disclosure.

FIG. 4 is a schematic view showing a structure of a bearing surface of a carrying platform of the film removing device provided by an embodiment of the present disclosure.

FIG. 5 is a schematic view showing a structure of a bearing surface of a carrying platform of the film removing device provided by another embodiment of the present disclosure.

FIGS. 6-8 provide an example as to how to precisely determine the initial position of a removed film.

### DETAILED DESCRIPTION OF THE PRESENT DISCLOSURE

The technical solution in the embodiments of the present disclosure will be fully and clearly described in more detail in conjunction with the attached drawings in the embodiments of the present disclosure. Obviously, the described embodiments are only some of the embodiments of the present disclosure, nor all embodiments. Based on the embodiments of the present disclosure, all other embodiments envisioned by those skilled in the art without creative work are within the protection scope of the present disclosure.

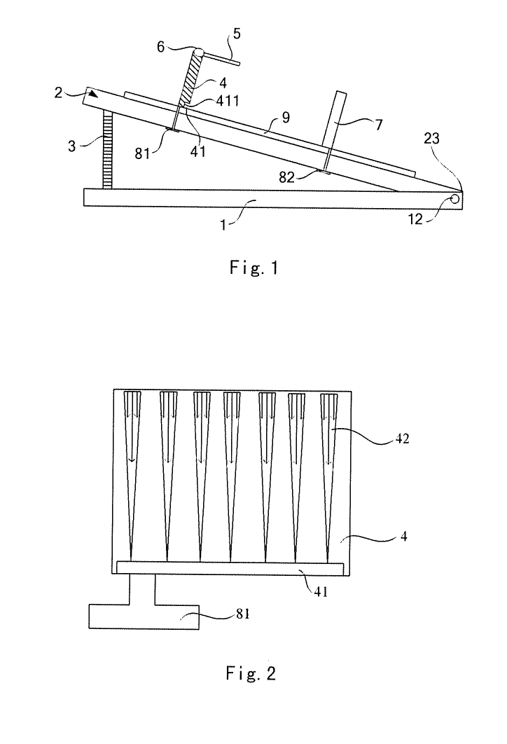

Please refer to FIG. 1 and FIG. 2. FIG. 1 is a schematic view showing structure of a film removing device provided by an embodiment of the present disclosure; and FIG. 2 is a schematic view showing structure of the first baffle of the film removing device provided by an embodiment of the present disclosure.

As shown in FIG. 1 and FIG. 2, the present embodiment of the disclosure provides a film removing device. The film removing device includes a base 1, a carrying platform 2 and a first baffle 4. A face of the carrying platform 2 facing away from the base 1 is bearing face. The carrying platform 2 is mounted on the base 1. A first side edge 23 and a second side edge of the bearing surface are opposite and parallel to each other. The first side edge 23 is in parallel to a surface of the base 1 facing towards the carrying platform 2. In the direction from the first side edge 23 towards the second side edge, the distance between the bearing surface and the base 1 can be increased. The first baffle 4 is mounted on the carrying platform 2 and is located on a side of the carrying platform 2 facing away from the base 1. The first baffle 4 has: a sealing face, which is hermetically matched with a face of a substrate 9 facing away from the carrying platform 2 when the substrate 9 to be processed is placed on the bearing surface; and a notch 41, the inner walls of which are cooperated with the face of the substrate 9 to be processed facing away from the carrying platform 2 to form a collecting slot opening to the first side edge 23 of the bearing surface when the substrate 9 to be processed is placed on the bearing surface. The inner walls of the notch 41 are provided with a stop face 411 facing towards the first side edge 23. The stop face 411 is in connected with the sealing face and the stop face 411 forms a bottom face of the collecting slot opposite to the opening. As shown in FIG. 2, the first baffle 4 has a number of liquid guiding holes 42 formed therein. The opening at one end of each of the liquid guiding holes 42 is located at a side of the first baffle 4 facing away from the carrying platform 2, and the opening at the other end is located at an inner wall of the notch 41.

When the film removing device is used to remove film, first, the substrate 9 to be processed is flatly placed on the carrying platform 2, and the sealing face of the first baffle 4 is hermetically matched with the face of the substrate 9 facing away from the carrying platform. The inner walls of the notch 41 are cooperated with the face of the substrate 9 facing away from the carrying platform 2 to form a collecting slot opening towards the first side edge 23 of the bearing surface. The inner walls of the notch 41 are provided with a stop face 411 facing towards the first side edge 23. When etchant is introduced from the openings of the liquid guiding holes 42 located at the side of the first baffle 4 facing away from the carrying platform 2, the etchant can flow out from the openings at the other end of the liquid guiding holes 42 located at an inner wall of the notch 41 and can be collected in the collecting slot. Because in the direction from the first side edge 23 towards the second side edge, the distance between the bearing surface of the carrying platform 2 and the base 1 can be increased, that is, the bearing surface is gradually raised along the direction from the first side edge 23 towards the second side edge, the etchant in the collecting slot can flow from the stop face 411 to the first side edge 23 of the carrying platform towards which the stop face 411 is facing. Therefore, the etchant can remove the film on the substrate 9 when it passes by. In this way, the removed portion of the film can have distinct removed boundary at the stop face 411, so when the thickness of the film is determined based on the segment difference, the tested thickness of the film can be more accurate.

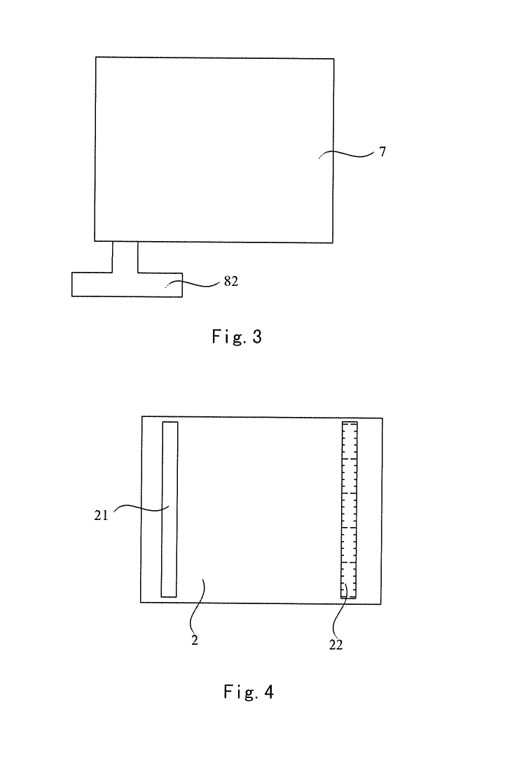

As shown in FIG. 1 and FIG. 3, in an embodiment of the present disclosure, the film removing device also includes a second baffle 7 mounted on the carrying platform 2 and located on a side of the carrying platform 2 facing away from the base 1. The side face of the second baffle 7 facing towards the first baffle 4 is in parallel to the first baffle 4, and the second baffle 7 is located at a side of the first baffle 4 facing towards the first side edge 23 of the bearing surface.

By providing the second baffle 7, the removed portion of the film can be defined between the first baffle 4 and the second baffle 7, defining the removed extent of the film.

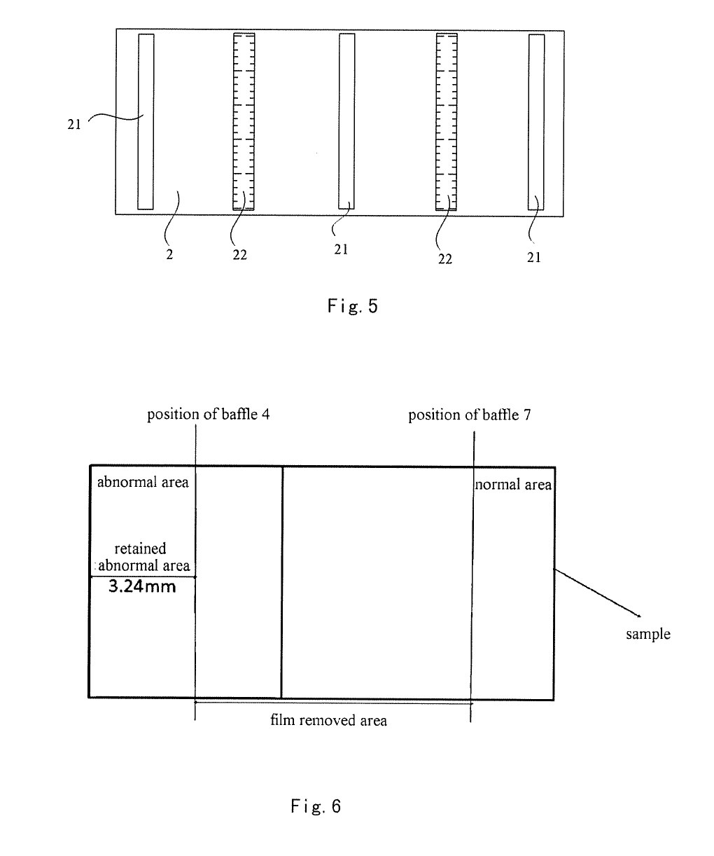

Please refer to FIG. 4 and FIG. 5 together. FIG. 4 is a schematic view showing structure of the bearing surface of the carrying platform of the film removing device provided by an embodiment of the present disclosure; and FIG. 5 is a schematic view showing structure of the bearing surface of the carrying platform of film removing device provided by another embodiment of the present disclosure.

As shown in FIG. 1 and FIG. 4, in a specific embodiment, the first baffle 4 and the second baffle 7 are mounted on the carrying platform, in detail, in the following way: the carrying platform 2 is provided with a slideway 21 extending along the direction perpendicular to the first side edge 23. The first baffle 4 and the second baffle 7 are mounted in the slideway 21 in a way that they can slide along the extending direction of the slideway 21 through locking mechanisms.

In a specific embodiment, the slideway 21 can be slideway hole through the thickness direction of the carrying platform 2. As shown in FIG. 5, the number of the slideway(s) 21 can be plurality.

The locking mechanism can be locking screw, as shown in FIG. 1, locking screw 81 and locking screw 82. The screw shaft of the locking screw 82 is in threaded fit with the first baffle 7 through the sideway hole, and a face of the screw cap of the locking screw 82 facing towards the carrying platform 2 is abutted against a surface of the carrying platform facing away from the bearing surface.

As shown in FIG. 1 and FIG. 4, in a specific embodiment, the bearing surface of the carrying platform 2 is formed with a first graduated scale 22 whose graduations are extending along a direction perpendicular to the first side edge 23 of the bearing surface, which is advantageous to roughly determine the initial position of the removed film.

As shown in FIG. 5, the number of the graduated scale(s) 22 can be plurality. When the number of the slideways 21 is plurality, each of the first graduated scales 22 can be located between two neighboring slideways. In this way, a plurality of substrates 9 to be processed can be placed between neighboring slideway 21 and the first graduated scale 22, and can be secured directly under the first baffle 4 so that the films on a number of substrates 9 can be removed simultaneously.

As shown in FIG. 1 and FIG. 4, in a specific embodiment, the film removing device also includes a second graduated scale 5 mounted on the first baffle 4. The second graduated scale 5 is in parallel to the first graduated scale 22 and is cooperated with the first graduated scale 22 to form a vernier caliper structure which is used to precisely determine the initial position of the removed film. The projection of zero graduation line of the second graduated scale 5 on the bearing surface is in the same line with the projection of the stop face 411 on the bearing surface. It can be followed that the projection of the intersection line between the stop face 411 and the surface of the substrate 9 to be processed facing away from the carrying platform 2 on the bearing surface is in the same line with the projection of the zero graduation line of the second graduated scale 5 on the bearing surface.

A microscope 6 is mounted on the second graduated scale 5 and can slide along the graduation direction of the second graduated scale 5 to read the aligned state of a certain graduation point on the second graduated scale 5 with a graduation on the first graduated scale 22.

The readings of the vernier caliper can be obtained by observing the aligned state of the graduations of the second graduated scale 5 and the first graduated scale 22 through the microscope 6. Because the projection of the intersection line between the stop face 411 and the surface of the substrate 9 to be processed facing away from the carrying platform 2 is in the same line with the projection of the zero graduation line of the second graduation scale 5 on the bearing surface, it can be followed that the position of the intersection line between the stop face 411 and the surface of the substrate 9 to be processed facing away from the carrying platform 2, that is, the initial position of the removed film, can be determined. Therefore, a precise controlling and positioning of the initial position of the removed film can be achieved.

As to how to precisely determine the initial position of the removed film by using the first graduated scale 22 and the second graduated scale 5, the following will be described with reference to FIGS. 6-8.

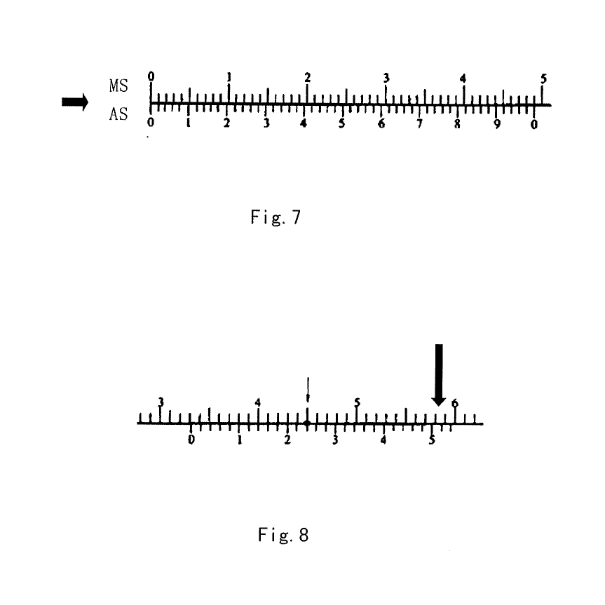

As shown in FIG. 7, the first graduated scale 22 is a main scale (MS), used for coarse tuning, with a precision of 1 mm; the second graduated scale 5 is an auxiliary scale (AS), used for fine tuning, with a precision of 0.02 mm. The two graduated scales can be combined together to form a vernier caliper structure.

With reference to FIGS. 6-8 as an example, the initial position of the removed film can be determined, mainly by the following several steps:
adjusting the inclination of the bearing surface of the carrying platform 2 by means of a lifting device 3 so that the bearing surface of the carrying platform 2 can be parallel to the upper surface of the base 1;
adjusting the first baffle 4 to a position away from a left edge of abnormal area of the film about 3 mm (coarse tuning);
moving the microscope 6 on the second graduated scale 5 to align the microscope 6 and the 12^{th} graduation on the second graduated scale 5 and securing the microscope 6;
moving the first baffle 4 to the right, observing through the microscope 6, to align the microscope 6 and the nearest graduation on the first graduated scale 22 and securing the first baffle 4 (fine tuning). At this time, the distance from the first baffle 4 to the left edge of the abnormal area of the film is about 3.24 mm; by adjusting twice, the precise initial position can be determined; and
adjusting the inclination of the bearing surface of the carrying platform 2 by means of the lifting device 3 to make the bearing surface incline a certain angle relative to the base 1; and injecting a kind of removing liquid into the first baffle 4 to remove the film.

As shown in FIG. 1 and FIG. 2, in a specific embodiment, the liquid guiding holes 42 are tapering through holes. The axis of the tapering through hole is perpendicular to a plane where the bearing surface of the carrying platform 2 is located. In a direction from the opening at the side of the first baffle 4 facing away from the carrying platform 2 to the opening at the inner wall of the notch, the diameter of the tapering through hole is gradually decreased. The structure of the tapering through hole can cause the etchant to flow out slowly from the opening with small diameter and collect in the collecting slot.

As shown in FIG. 1, in a specific embodiment, at the first side edge 13 of the bearing surface, the carrying platform 2 can be pivotally mounted on the base 1 through a pivot shaft 12. The axis of the pivot shaft 12 is in parallel to the first side edge 23. A lifting device 3 is connected between the base 1 and the carrying platform 2 to drive the carrying platform 2 to rotate around the pivot shaft 12.

The inclination of the bearing surface of the carrying platform 2 can be controlled by means of the lifting device 3, so that the flow rate of the etchant from the stop face 311 to the first side edge 23 of the bearing surface towards which the stop face 411 is facing can be controlled, and the removing of the film can be more uniform.

Obviously, those skilled in the art can make various modifications and variations without departing from the spirit and scope of the present disclosure. In this way, if those modifications and variations are within the scope of the claims of the present disclosure and its equivalents, the present disclosure is meant to include those modifications and variations.

1. A film removing device, comprising:
a base;
a carrying platform, wherein a face of the carrying platform facing away from the base is a bearing face; the carrying platform is mounted on the base, a first side edge and a second side edge of the carrying platform are opposite and parallel to each other, the first side edge is in parallel to a surface of the base facing towards the carrying platform, and in a direction from the first side edge towards the second side edge, a distance between the bearing surface and the base is increased;
a first baffle, which is mounted on the carrying platform and is located on the side of the carrying platform facing away from the base; the first baffle having:
a sealing face, which is hermetically matched with a face of the substrate facing away from the carrying platform when the substrate to be processed is placed on the bearing surface; and
a notch, the inner walls of which are cooperated with the face of the substrate facing away from the carrying platform when the substrate to be processed is placed on the bearing surface to form a collecting slot opening to the first side edge of the bearing surface, wherein the inner walls of the notch are provided with a stop face facing towards the first side edge, the stop face is in connected with the sealing face and the stop face forms a bottom face of the collecting slot opposite to the opening;
wherein the first baffle has a plurality of liquid guiding holes formed therein, the opening at one end of each of the liquid guiding holes is located at a side of the first baffle facing away from the carrying platform, and the opening at the other end is located at an inner wall of the notch.

2. The film removing device according to claim 1, wherein, the carrying platform is provided with a slideway extending along a direction perpendicular to the first side edge, the first baffle can be mounted in the slideway in a way that the first baffle can slide along the extending direction of the slideway by a a locking mechanism.

3. The film removing device according to claim 2, wherein the slideway is a slideway hole through the thickness direction of the carrying platform.

4. The film removing device according to claim 3, wherein, the locking mechanism is a locking screw, a screw shaft of the locking screw is in threaded fit with the first baffle through the sideway hole, and a face of a screw cap of the locking screw facing towards the carrying platform is abutted against a surface of the carrying platform facing away from the bearing surface.

5. The film removing device according to claim 1, wherein, the bearing surface of the carrying platform is provided with a first graduated scale with graduations extending along a direction perpendicular to the first side edge of the bearing surface.

6. The film removing device according to claim 5, wherein, it further comprising a second graduated scale on the first baffle, the second graduated scale and the first graduated scale are matched to form a vernier caliper structure, and the projection of the zero graduation line of the second graduated scale on the bearing surface is in a same line with the projection of the stop face on the bearing surface.

7. The film removing device according to claim 6, further comprising a microscope mounted on the first graduated scale for reading the aligned state of the graduations of the second graduated scale and the first graduated scale.

8. The film removing device according to claim 1, wherein the liquid guiding holes are tapering through holes, the axis of the tapering through hole is perpendicular to a plane where the bearing surface of the carrying platform is located; and, in a direction from the opening at the side of the first baffle facing away from the carrying platform towards the opening located at the inner wall of the notch, the diameter of the tapering through hole is gradually decreased.

9. The film removing device according to claim 1, wherein at the first side edge of the bearing surface, the carrying platform is pivotally mounted on the base through a pivot shaft; an axis of the pivot shaft is parallel to the first side edge; and a lifting device is connected between the base and the carrying platform to drive the carrying platform to rotate around the pivot shaft.

10. The film removing device according to claim 1, further comprising a second baffle mounted on the carrying platform and located on the side of the carrying platform facing away from the base, wherein a side face of the second baffle facing towards the first baffle is in parallel to the stop face of the first baffle; and the second baffle is located at a side of the first baffle facing towards the first side edge of the bearing surface.
